(19) United States
(12) Patent Application Publication
(10) Pub. No.: US 2017/0187993 A1
(43) Pub. Date: Jun. 29, 2017

(54) UNMANNED AERIAL VEHICLE INTEGRATION WITH HOME AUTOMATION SYSTEMS

(71) Applicant: Echostar Technologies L.L.C., Englewood, CO (US)

(72) Inventors: Henry Gregg Martch, Parker, CO (US); Derek Dalmer, Aurora, CO (US); Michael Dornik, Englewood, CO (US)

(73) Assignee: Echostar Technologies L.L.C., Englewood, CO (US)

(21) Appl. No.: 14/982,366

(22) Filed: Dec. 29, 2015

(51) Int. Cl. H04N 7/18; G05B 15/02

(52) U.S. Cl. CPC H04N 7/185; G05B 15/02; G05B 2219/2642

(57) ABSTRACT

Various arrangements are provided for using an unmanned aerial vehicle with a home automation system. The home automation host system may determine that a home automation event has occurred. The system may determine to perform unmanned aerial vehicle (UAV) surveillance of the home in response to the home automation event. Deployment of a UAV may be triggered in response to determining to perform the UAV surveillance of the home. Video may then captured by the UAV of a portion of the home, possibly corresponding to the location of the home automation event. The video captured by the UAV of the portion of the home in association with an indication of the home automation event that triggered deployment of the UAV may be recorded.

### BACKGROUND

People are increasingly installing devices that improve home safety and security aspects both inside and outside of the home, such as door and window monitors, video cameras, smoke detectors, carbon monoxide detectors, sound-sending devices and other safety- and security-related hardware in and around their homes. While such devices can be useful in determining when a safety or security risk may be present, oftentimes such information can be inconclusive. For example, if a door monitor indicates that a door is open, is a burglar breaking and entering? Or did a resident accidentally leave the door ajar? Having video surveillance of the door, for example, may be useful in addressing such concerns, but having video surveillance at every possible point of concern at a home may be cost prohibitive, unsightly, or both. Further, such video surveillance may leave significant coverage gaps around the exterior and interior of the home. For instance, a fire may be in progress but smoke and flames of the fire may only be visible in locations outside of the fields-of-view of fixed cameras on the exterior or interior of the home.

### SUMMARY

Various arrangements for performing dynamic video surveillance of a home or other form of structure are presented. Systems, methods, devices, and computer-readable mediums may receive home automation data from a plurality of home automation devices via wireless communication. It may be determined that a home automation event has occurred. Unmanned aerial vehicle (UAV) surveillance of the home may be determined to be performed in response to the home automation event. Deployment of a UAV in response to determining to perform the UAV surveillance of the home may be triggered. Video captured by the UAV of a portion of the home may be received from the UAV and recorded.

Embodiments of such arrangements may include one or more of the following features: The home automation event may be a scheduled aerial patrol event of an exterior and interior of the home at least partially based on a time of day that follows a user-created patrol route. The home automation event may be unscheduled and may be based on home automation data received from a home automation device of the plurality of home automation devices. Determining to perform the UAV surveillance of the home in response to the home automation event may include: comparing the home automation data received from the home automation device with a stored database of defined responses, wherein the stored database of defined responses indicates various instances of home automation data that are to trigger UAV surveillance; and determining that the home automation data matches a defined response of the stored database of defined responses, wherein the defined response indicates that UAV surveillance is to be performed and a type of UAV surveillance to perform. The video captured by the UAV of the portion of the home may be streamed to a user's mobile device, such as a cellular phone, via a network connection.

Additionally or alternative, embodiments of such arrangements may include one or more of the following features: A patrol route for the UAV may be created at least partially around the exterior of the home based on coordinates defined by a user. Creation of a patrol route may include: a first set of coordinates being received from a UAV or mobile device of the user at a first waypoint to be included as part of the patrol route, wherein the mobile device is physically located at the first set of coordinates; a second set of coordinates being received from the UAV or the mobile device of the user at a second waypoint to be included as part of the patrol route wherein the mobile device is physically located at the second set of coordinates; and the patrol route being defined to include the first waypoint and the second waypoint. Creation of a patrol may include receiving, for each waypoint, a desired altitude for the UAV from the mobile device of the user, wherein defining the patrol route is at least partially based on the desired altitude received for each waypoint. Determining to perform the UAV surveillance of the portion of the home in response to the home automation event may include selecting a type of UAV surveillance from the group consisting of: spot surveillance and patrol route surveillance, wherein the spot surveillance involves the UAV proceeding to a defined waypoint associated with received home security data and the patrol route surveillance comprises the UAV flying along a defined patrol route.

### DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of home automation system that includes a UAV.

FIG. 2A shows an embodiment of an exterior UAV patrol route, home, and UAV.

FIG. 2B shows an embodiment of an interior UAV patrol route and home.

FIG. 3 illustrates an embodiment of a system including a home automation host that executed a UAV monitoring service.

FIG. 4 illustrates an embodiment of a method for dynamic video surveillance of a home.

FIG. 5 illustrates an embodiment of a method for creating a patrol route for a UAV.

FIG. 6 illustrates an embodiment of a computer system that may be incorporated as part of various computerized devices.

### DETAILED DESCRIPTION

Rather than having a plethora of video cameras mounted to monitor the inside and outside of a home, one or more unmanned aerial vehicles (UAVs), also referred to as drones, that have on-board surveillance equipment may be used to monitor the home's exterior and/or interior. Since a UAV is mobile, the UAV can provide enhanced coverage of the interior and/or exterior of the structure, with the UAVs behavior being based, at least in part, on information gather by other safety- and/or security-related home automation devices present at the home. The UAV may be used to monitor security-related, safety-related, child-related, pet-related, disability-related (physical and mental), elderly-related (e.g., monitoring location and whether medicine has been taken as scheduled), pest-related, and other forms of events.

Such a UAV can operate in multiple modes. The UAV may be managed by a UAV service of a home automation host system. The home automation host system may communicate with the UAV and provide instructions as to what form of surveillance is desired. For instance, the UAV service may schedule periodic patrols that examine the exterior and/or interior of the home. Such patrols may be in response to a time of day or an amount of time elapsing. Such patrols may follow a predefined route defined by a user and may result in video and/or audio being streamed to the home automation host system for recording and/or analysis. The UAV may also be triggered to either patrol or proceed to a particular location (e.g., a waypoint) in response to data retrieved from home automation devices. For instance, if a motion detector indicates that movement is present in front of a home's front door, the UAV service being executed by the home automation host system may trigger the UAV to pass through or hover at a waypoint associated with monitoring the front door. Video may then be captured of the front door and stored and/or streamed to a user for viewing. The UAV, additionally or alternatively, may be triggered to patrol the exterior and interior of the home (e.g., to search for the source of the movement if it has moved from the vicinity of the door).

Interior patrolling may be especially useful if a break-in is in progress with a perpetrator inside the home. A small drone (e.g., a handheld drone) may be able to easily maneuver indoors and may be disruptive to the break-in by confirming that a break-in is in progress (e.g., a false alarm is not present), providing video to a homeowner, making noise via a speaker to alert the burglar that he is being recorded (e.g., a message recorded by a user of the UAV may be played or live audio from the user or police may be output), flashing lights to distract the burglar, and/or deploying a deterrent (e.g., mace or pepper spray).

Since homes typically vary in floorplan and obstacles around the exterior of the home, a user may define a patrol route and/or particular waypoints that are useful for monitoring security-critical and high-value portions of a home's exterior and/or interior, such as windows, doors, cribs, beds, jewelry cases, skylights, etc. Using a mobile device, a user may physically bring the mobile device to the locations along the exterior and/or interior of the home which are to be set as waypoints. The user may also specify an altitude and/or direction that a camera and/or microphone of the UAV should be pointed while at the waypoint. The waypoint may further be tied to a particular location, object, or home automation device. For instance, a particular waypoint may be associated with a window sensor or the window on which the window sensor is installed. Thus, if data is collected from the window sensor that is indicative of a potential problem, the UAV may be instructed to proceed to the associated waypoint, altitude, and point the camera and/or microphone in the associated direction to capture video and/or audio for recording and/or streaming to a user.

The following description focuses on the use of a UAV in relation to the exterior and interior home. However, it should be understood that these embodiments can be equally applied to other forms of a structure, such as an office building, factory, warehouse, etc. Further, the embodiments herein can be applied to other locations that do not necessary involve a structure, such as a park, wildlife habitat, road, or the interior of any form of structure, etc. While security is one major application of the embodiments of UAVs detailed herein, other embodiments may be focused on other applications, such as monitoring of the elderly. For instance, a patrol route may monitor for an elderly person who has fallen down or has a detectable medical incident (e.g., seizure). The UAV could be directed to the elderly person's location, provide interaction with the elderly person by establishing a communication channel with a caregiver. The UAV may even, in some embodiments, carry a payload, such as the elderly person's medicine (e.g., asthma medication, nitroglycerin).

Another embodiment in which the use of a UAV as detailed below may be applicable is pest control. An on-board payload of the UAV may be used to exterminate and/or deter pests such as raccoons, squirrels, cats, dogs, vermin, bugs, etc. One possible external application would be the delivery of an extermination spray to a wasp nest. Still other embodiments may have applications involving leisure activities, such as the delivery of candy, music, confetti being sprayed, a message, etc.

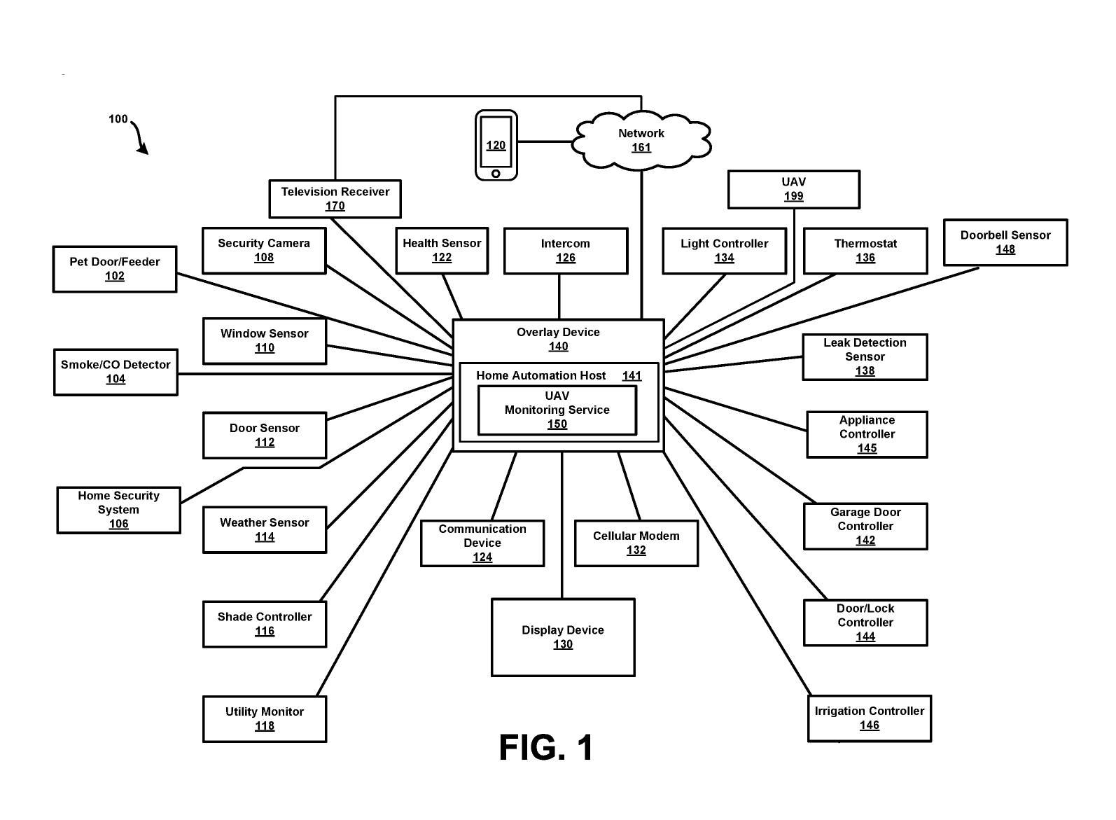

The deployment and use of the UAV may be managed as part of a larger home automation system, such as that detailed in relation to FIG. 1. FIG. 1 illustrates an embodiment of a home automation system 100 hosted by an overlay device 140. Overlay device 140 refers to a device that can be connected with a separate display device 130, such that information regarding the home automation system is presented by display device 130. In some embodiments, overlay device 140 receives data from a separate device, such as television receiver 170, and overlays home automation data and user interfaces over television (e.g., television programming) signals output by television receiver 170. Television receiver 170 may be configured to receive television programming from a satellite-based television service provider; in other embodiments other forms of television service provider networks may be used, such as an IP-based network (e.g., fiber network), a cable based network, a wireless broadcast-based network, etc.

In some embodiments, overlay device 140 may be coupled between television receiver 170, which may be in the form of a set top box, and display device 130, which may be a television. In such embodiments, television receiver 170 may receive, decode, descramble, decrypt, store, and/or output television programming. Television receiver 170 may output a signal, such as in the form of an HDMI signal. Rather than be directly input to display device 130, the output of television receiver 170 may be input to overlay device 140. Overlay device 140 may receive the video and/or audio output from television receiver 170. Overlay device 140 may add additional information to the video and/or audio signal received from television receiver 170. The modified video and/or audio signal may be output to display device 130 for presentation. In some embodiments, overlay device 140 has an HDMI input and an HDMI output, with the HDMI output being connected to display device 130.

In the illustrated embodiment of FIG. 1, overlay device 140 serves as a home automation host system. In other embodiments, it should be understood that television receiver 170 may serve as the home automation host system. Therefore, in other embodiments, functionality attributed to overlay device 140 may instead be fully or partially implemented by television receiver 170. In still other embodiments, a different device, such as a dedicated computerized device, or another device illustrated as part of home automation system 100, can serve as the home automation host system.

Overlay device 140 may be configured to communicate with multiple home automation devices. The devices with which overlay device 140 communicates may use different communication standards, including both wireless and wired communication standards. For instance, one or more devices may use a ZigBee® communication protocol while one or more other devices communicate with the television receiver using a Z-Wave® communication protocol. Other forms of local wireless communication may be used by devices and overlay device 140. For instance, overlay device 140 and one or more devices may be configured to communicate using a wireless local area network, which may use a communication protocol such as IEEE 802.11.

Using overlay device 140 to present automation information via display device 130 may have additional benefits. For instance, multiple devices may provide input video to overlay device 140. For instance, television receiver 170 may provide television programming to overlay device 140, a DVD/BLU-RAY player may provide overlay device 140, and a separate internet-TV device may stream other programming to overlay device 140. Regardless of the source of the video/audio, overlay device 140 may output video and/or audio that has been modified to include home automation information and output to display device 130. As such, in such embodiments, regardless of the source of video/audio, overlay device 140 may modify the audio/video to include home automation information and, possibly, solicit for user input. For instance, in some embodiments, overlay device 140 may have four video inputs (e.g., four HDMI inputs) and a single video output (e.g., an HDMI output). In other embodiments, such overlay functionality may be part of television receiver 170. As such, a separate device, such as a Blu-ray player, may be connected with a video input of television receiver 170, thus allowing television receiver 170 to overlay home automation information when content from the Blu-Ray player is being output to display device 130.

Regardless of whether television receiver 170 is itself configured to provide home automation functionality and output home automation input for display via display device 130 or such home automation functionality is provided via overlay device 140, home automation information may be presented by display device 130 while television programming is also being presented by display device 130. For instance, home automation information may be overlaid or may replace a portion of television programming (e.g., broadcast content, stored content, on-demand content, etc.) presented via display device 130.

In some embodiments, a separate device may be connected with overlay device 140 to enable communication with home automation devices. For instance, communication device 124 may be in communication with overlay device 140. Communication device 124 may be in the form of a dongle. Communication device 124 may be configured to allow for Zigbee®, Z-Wave®, and/or other forms of wireless or wired communication. The communication device may connect with overlay device 140 via a USB port or via some other type of (wired) communication port. Communication device 124 may be powered by the overlay device (or television receiver, if the television receiver is serving as the home automation host system) or may be separately coupled with a power source. In some embodiments, overlay device 140 may be enabled to communicate with a local wireless network and may use communication device 124 in order to communicate with devices that use a ZigBee® communication protocol, Z-Wave® communication protocol, and/or some other home wireless communication protocols.

Communication device 124 may also serve to allow additional components to be connected with overlay device 140 or television receiver 170. For instance, communication device 124 may include additional audio/video inputs (e.g., HDMI), a component, and/or a composite input to allow for additional devices (e.g., Blu-ray players) to be connected with television receiver 170 and/or overlay device 140. Such connection may allow video from such additional devices to be overlaid with home automation information. Whether home automation information is overlaid onto video may be triggered based on a user's press of a remote control button.

Regardless of whether overlay device 140 uses communication device 124 to communicate with home automation devices, overlay device 140 may be configured to output home automation information for presentation to a user via display device 130, which may be a television, monitor, or other form of device capable of presenting visual information. Such information may be presented simultaneously with television programming received by television receiver 170. Television receiver 170 may also, at a given time, output television programming that may be augmented or replaced by home automation information by overlay device 140. The user may be able to provide input to television receiver 170 and/or overlay device 140 to control the home automation system hosted by either television receiver 170 or by overlay device 140, as detailed below.

Television receiver 170 or overlay device 140 may be configured to communicate with one or more wireless devices, such as (wireless) mobile device 120. Mobile device 120 may represent a tablet computer, cellular phone (e.g., smartphone), laptop computer, remote computer, or some other device through which a user may desire to control home automation settings and view home automation information. Such a mobile device also need not be wireless, such as a desktop computer. Television receiver 170, communication device 124, or overlay device 140 may communicate directly with mobile device 120, or may use a local wireless network, such as network 161. Mobile device 120 may be remotely located and not connected with a same local wireless network. Via the internet, television receiver 170 or overlay device 140 may be configured to transmit a notification and/or other information to mobile device 120 regarding home automation information. For instance, in some embodiments, a third-party notification server system, such as the notification server system operated by Apple®, may be used to send such notifications to mobile device 120.

In some embodiments, a location of mobile device 120 may be monitored. For instance, if mobile device 120 is a cellular phone, when its position indicates it is located near a door, the door may be unlocked. A user may be able to define which home automation functions are controlled based on a position of mobile device 120. Other functions could include opening and/or closing a garage door, adjusting temperature settings, turning on and/or off lights, opening and/or closing shades, etc. Such location-based control may also take into account the detection of motion via one or more motion sensors that are integrated into other home automation devices and/or stand-alone motion sensors in communication with television receiver 170.

In some embodiments, little to no setup of network 161 may be necessary to permit television receiver 170 to stream data out to the Internet. For instance, television receiver 170 and network 161 may be configured, via a service such as SLING or other video streaming service, to allow for video to be streamed from television receiver 170 to devices accessible via the Internet. Such streaming capabilities may be “piggybacked” to allow for home automation data to be streamed to devices accessible via the Internet. For example, U.S. patent application Ser. No. 12/645,870, filed on Dec. 23, 2009, entitled “Systems and Methods for Remotely Controlling a Media Server via a Network”, which is hereby incorporated by reference, describes one such system for allowing remote access and control of a local device. U.S. Pat. No. 8,171,148, filed Apr. 17, 2009, entitled “Systems and Methods for Establishing Connections Between Devices Communicating Over a Network”, which is hereby incorporated by reference, describes a system for establishing connection between devices over a network. U.S. patent application Ser. No. 12/619,192, filed May 19, 2011, entitled “Systems and Methods for Delivering Messages Over a Network”, which is hereby incorporated by reference, describes a message server that provides messages to clients located behind a firewall.

Mobile device 120 may serve as an input device for television receiver 170 and/or overlay device 140. For instance, mobile device 120 may be a tablet computer that allows text to be typed by a user and provided to television receiver 170. Such an arrangement may be useful for text messaging, group chat sessions, or any other form of text-based communication. Other types of input may be received for the television receiver from a tablet computer or other device as shown in the attached screenshots, such as lighting commands, security alarm settings and door lock commands. While mobile device 120 may be used as the input device for typing text, television receiver 170 may output for display text to display device 130. As another example, if a user needs to provide waypoints (such as GPS coordinates) to a home automation system, mobile device 120 may be brought to the physical location associated with a waypoint to log the associated coordinates.

In some embodiments, a cellular modem 132 may be connected with either overlay device 140 or television receiver 170. Cellular modem 132 may be useful if a local wireless network is not available. For instance, cellular modem 132 may permit access to the internet and/or communication with a television service provider. Communication with a television service provider may also occur via a local wireless or wired network connected with the Internet. In some embodiments, information for home automation purposes may be transmitted by a television service provider system to television receiver 170 or overlay device 140 via the television service provider's distribution network, which may include the use of satellites.

Various home automation devices may be in communication with television receiver 170 or overlay device 140. Such home automation devices may use disparate communication protocols. Such home automation devices may communicate with television receiver 170 directly or via communication device 124. Such home automation devices may be controlled by a user and/or have a status viewed by a user via display device 130 and/or mobile device 120. Home automation devices may include: smoke/carbon monoxide (CO) detector 104, home security system 106, pet door/feeder 102, security camera 108, window sensor 110, irrigation controller 146, weather sensor 114, shade controller 116, utility monitor 118, heath sensor 122, intercom 126, light controller 134, thermostat 136, leak detection sensor 138, overlay device 140, appliance controller 145, garage door controller 142, and doorbell sensor 148.

Door sensor 112 and lock controller 144 may be incorporated into a single device, such as a door lock and sensor unit, and may allow for a door's position (e.g., open or closed) to be determined and for a lock's state to be determined and changed. Door sensor 112 may transmit data to television receiver 170 or overlay device 140 that indicates the status of a door. Such status may indicate open or closed. When a status change occurs, the user may be notified as such via mobile device 120 or display device 130. Further, a user may be able to view a status screen to view the status of one or more door sensors throughout the location. Window sensor 110 and/or door sensor 112 may have integrated glass break sensors to determine if glass has been broken. Lock controller 144 may permit a door to be locked and unlocked and/or monitored by a user via television receiver 170 or overlay device 140. No mechanical or electrical component may need to be integrated separately into a door or door frame to provide such functionality. Such a single device may have a single power source that allows for sensing of the lock position, sensing of the door position, and for engagement and disengagement of the lock.

Additional forms of sensors not illustrated in FIG. 1 may also be incorporated as part of a home automation system. For instance, a mailbox sensor may be attached to a mailbox to determine when mail is present and/or has been picked up. The ability to control one or more showers, baths, and/or faucets from television receiver 170 and/or mobile device 120 may also be possible. Pool and/or hot tub monitors may be incorporated into a home automation system. Such sensors may detect whether or not a pump is running, water temperature, pH level, a splash/whether something has fallen in, etc. Further, various characteristics of the pool and/or hot tub may be controlled via the home automation system. In some embodiments, a vehicle dashcam may upload or otherwise make video/audio available to television receiver 170 or overlay device 140 when within range. For instance, when a vehicle has been parked within range of a local wireless network with which the home automation host is connected, video and/or audio may be transmitted from the dashcam to the television receiver for storage and/or uploading to a remote server.

Some or all of the devices of the embodiments detailed in relation to FIG. 1 may provide security-related or safety-related data to the home automation host 141 for use by UAV monitoring service 150. For instance, motion sensed by security camera 108, a door open message from door sensor 112, a smoke detected message from smoke/CO detector 104, and an open garage message from garage door controller 142 are all examples of messages that can be considered security or safety related. Home automation host 141 may use such data in determining how to control UAV 199.

UAV 199 can be capable of streaming video and/or audio gathered outside of a home to display device 130 via overlay device 140 (or television receiver 170) and/or streaming such video and/or audio to a remote server via network 161. Via a service provider's server system, the video and/or audio may be stream to mobile device 120 or any other remote computerized device through which an authorized user is logged in. In some embodiments, video and/or audio from UAV 199 may be retrieved directly by mobile device 120 from overlay device 140.

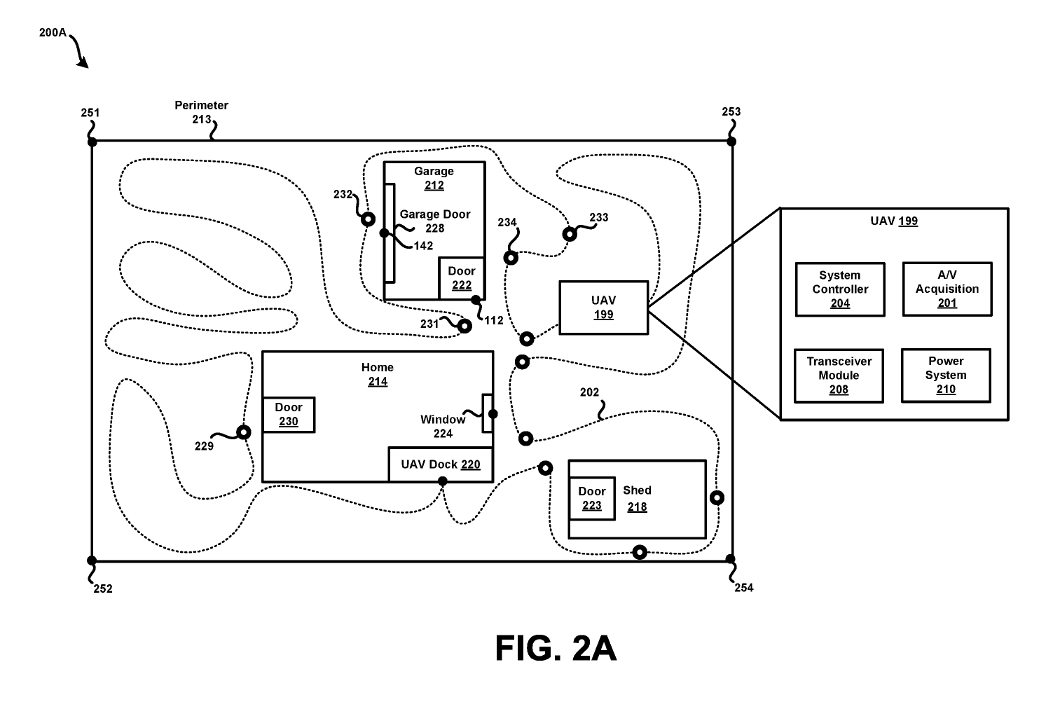

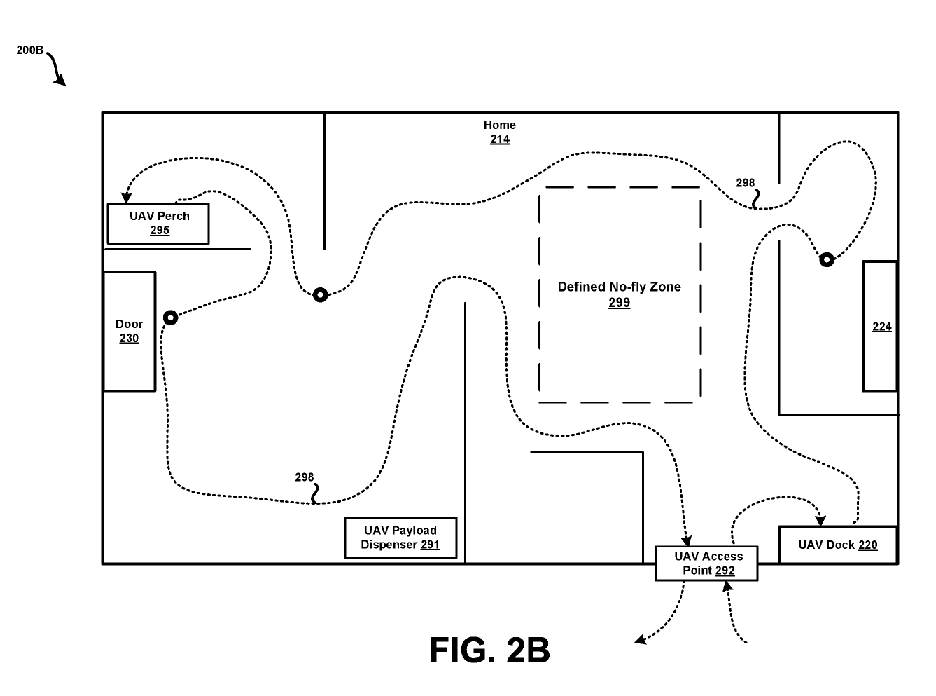

FIG. 2A shows an embodiment 200 of an exterior UAV patrol route, home, and UAV. In FIG. 2A, a user's property is illustrated, which includes home 214, garage 212, and shed 218. In the illustrated embodiment, garage 212 and shed 218 are detached from home 214. UAV 199 may be used to patrol the property including home 214, garage 212, and shed 218. When not in flight, UAV 199 may be stored by UAV dock 220. UAV dock 220 may provide recharging for a power source of UAV 199 and may serve as a safe place to store UAV 199 when it is not in flight. Further, while present in UAV dock 220, one or more cameras present on UAV 199 may serve as a fixed-location camera such as to provide monitoring of a room or outdoor location.

When UAV 199 leaves UAV dock 220 it may follow a predefined patrol route 202. This patrol route 202 may be used in multiple ways. First, such as according to a schedule, the UAV may follow the patrol route and pass-through and/or posit various waypoints along the patrol route. The UAV may also have instructions as to which direction a camera and/or microphone of UAV 199 should be pointed at various waypoints. If the UAV is responding to a particular security or safety threat identified in data received from another home automation device, UAV 199 may still follow the patrol route but may not pause at any waypoint besides a waypoint associated with the home automation device that resulted in triggering the UAV to investigate. In some embodiments, the UAV may ignore the patrol route and may fly directly to the waypoint associated with the home automation device that provided data resulting in triggering the UAV to take flight.

When UAV 199 is instructed to perform a patrol, UAV 199 may leave UAV dock 220 and begin to follow patrol route 202. From UAV dock 220, UAV 199 may fly to waypoint 229. Waypoint 229, in addition to being a set of coordinates (e.g., GPS coordinates), may include an altitude, and a direction in which a camera and/or microphone of UAV 199 is to be directed. Further waypoint 229 may be associated with a particular object or home automation device. In the illustrated embodiment of FIG. 2A, waypoint 229 is associated with door 230. If a waypoint is associated with a particular home automation device or object, the camera and/or microphone of the UAV may by default be configured to point directly at the home automation device or object when the UAV is at the waypoint. When UAV 199 follows patrol route 202 to waypoint 229, UAV 199 may hover at waypoint 229 for predefined period of time, at the predefined altitude, with its camera and/or microphone pointed in the predefined direction (or panning/tilting zooming according to a predefined set of instructions). In other embodiments, UAV 199 may not hover but may continue on its flight through waypoint 229, thus the UAV passes through waypoint 229 at the appropriate altitude with its camera and/or microphone pointed in the appropriate direction but does not hover for a predefined period of time. Mobile device 120 may be used to re-task the UAV—such as by a user providing mobile device 120 a command to perform an action that is not on a defined patrol route. For instance, such a command may request the UAV to remain in a particular spot (either airborne or landed on a perch) to serve as a “fixed” location camera for a time. As another example, the UAV may be instructed to save power and/or recharge using the UAV dock.

It should be noted that while no other waypoint is illustrated as between UAV dock 220 and waypoint 229, this is for simplicity of the drawing only. Rather, multiple other waypoints may be present resulting in UAV 199 taking the circuitous route from UAV dock 220 to waypoint 229. In other embodiments, the circuitous route may be due not to additional waypoints but rather to UAV 199 identifying a large open space through which it can safely patrol. When UAV 199 is not at a waypoint, video and/or audio may still be captured and transmitted to a home automation host system. In other embodiments, only snippets of video captured while at predefined waypoints may be transmitted to the home automation host system.

After either hovering (also referred to as pausing) at or passing through waypoint 229, UAV 199 may proceed to waypoint 231. Waypoint 231 may be associated with door sensor 112. Therefore, if a security issue is ever detected by door sensor 112, UAV 199 may proceed to waypoint 231, hover at an altitude associated with waypoint 231, and point its camera and/or microphone in a predefined direction (which is likely directly at door 222).

UAV 199 may continue the patrol from waypoint 231 by proceeding to waypoint 232. Waypoint 232 may also have an associated altitude which may differ from the altitude associated with waypoint 231. Waypoint 232 may be associated with garage door controller 142. Therefore, if a security issue is ever detected by garage door controller 142, UAV 199 may proceed to waypoint 232, hover at the altitude associated with waypoint 232, and points camera and/or microphone in the predefined direction associated with waypoint 232, which is likely directly at garage door 228. The amount of time spent hovering at waypoint 232 may be predefined and may differ from the amount of time spent hovering at other waypoints and may also depend on whether the UAV's visit to the waypoint is part of a routine patrol or was triggered by security data received from the home automation device associated with the particular waypoint. The duration of the hovering may additionally or alternatively be based on the UAV's available battery power, motion being detected by an on-board motion sensor, and/or some other variable.

From waypoint 232, UAV 199 may continue its patrol such as by proceeding to waypoint 233 then on to waypoint 234. It should be understood that a waypoint does not necessarily need to be associated with a particular home automation device. For example, waypoint 232 may have coordinates, an associated altitude, and/or direction in which the UAV's camera and/or microphone should be pointed, but waypoint 232 may not be associated with any particular home automation device. Such a waypoint may not be associated with any other object or may be associated with an object, such as a door or window. While FIG. 2A illustrates eleven waypoints, it should be understood that many more waypoints or possibly fewer waypoints, may be configured by a user for UAV patrols, responses to security and/or safety information received from home automation devices. Further, a waypoint does not need to be a fixed location—for instance, a person, such as an elderly relative, child, or sleepwalker could be a waypoint.

For this particular example, UAV 199 may continue to various waypoints to patrol window 224 and shed 218, such as door 223. While UAV 199 may have specific waypoints, by continually recording or streaming video and/or audio to the home automation host system, comprehensive or continuous coverage of all exterior walls (and possibly roofs) of home 214, garage 212, and/or shed 218 may be achieved. In some embodiments, which the patrol is occurring, if a display device with which the home automation host system is coupled is on, video and/or audio from UAV 199 may be output for presentation on all or a portion (e.g., picture-in-picture) of a screen of the display device and/or record locally or in the cloud. Once the patrol is complete, UAV 199 may return to UAV dock 220 or some other dock or perch until the next scheduled patrol or until the home automation host system triggers a visit to a particular waypoint in response to a home automation device providing triggering data to the home automation host system. In some embodiments, a home automation device may be associated with multiple waypoints. For example, if a smoke detector identifies smoke being present in home 214, this may trigger the UAV 199 to visit all waypoints associated with home 214 (possibly to the exclusion of waypoints associated with garage 212 and/or shed 218).

As an example of how UAV 199 may be used to respond to triggering security or safety data received by the home automation host system from a home automation device, consider garage door controller 142 providing data to the home automation host system indicative of garage door 228 opening. If this opening of the garage door is outside of a predefined time range specified by a user (e.g., outside of 6 AM-10 PM), home automation host system may trigger UAV 199 to visit waypoint 232. This may involve UAV 199 being instructed to follow patrol route 202 until waypoint 232 is reached. While waypoints 229 and 231 may be passed through, UAV 199 may not hover or pause at such waypoints. Rather, UAV 199 may first hover at waypoint 232 and may remain at waypoint 232 until receiving a further command or for predefined period of time which may be longer than the hover time used during a scheduled patrol at waypoint 232. In other embodiments, UAV 199 may proceed directly from UAV dock 220 to waypoint 232 without following patrol route 202. In some embodiments, UAV 199 may follow patrol route 202 either a clockwise or counterclockwise in order to reach a particular waypoint most efficiently (e.g., in the shortest amount of time).

UAV 199 may have various systems on board, including system controller 204, audiovisual acquisition module 201, transceiver module 208, and power system 210. System controller 204 may include one or more processors and one or more computer readable mediums that are used to store data and/or control operation of UAV 199. Audiovisual acquisition module 201 may include one or more (video and/or still) cameras and/or one or more microphones that are configured to receive still and/or motion video and record sound while UAV 199 is in flight. Transceiver module 208 may permit communication between UAV 199 and a home automation host system, such as a home automation host system hosted by an overlay device or television receiver or some other form of computerized device. Power system 210 may represent a rechargeable power source that can recharged as necessary to allow UAV 199 sufficient power to perform one or more patrols. In some embodiments, a non-rechargeable power system may be used, such as powered by fossil fuel.

In some embodiments, an outer boundary may be defined for UAV 199. For example, boundary points 251, 252, 253, and 254 may be define the outer limits of where UAV 199 is permitted to travel. For instance, if a user is manually controlling UAV 199, it may not be required to remain on patrol route 202. However, despite manually controlling UAV 199, flight outside of the perimeter 213 may be prohibited. In some embodiments, if UAV 199 is malfunctioning or having difficulty flying on course (e.g., due to high winds) and UAV 199 either violates or comes within a predefined distance of perimeter 213, UAV 199 may deactivate and be allowed to fall to the ground or may perform an emergency landing sequence such that UAV 199 lands on or near perimeter 213. In some embodiments, boundaries may also be set for altitude. Therefore UAV 199 may be prohibited from descending below or rising above predefined altitudes. One exception may be when UAV 199 is entering or leaving UAV dock 220.

While FIG. 2A illustrates an exterior UAV patrol route, home, and UAV, FIG. 2B illustrates an embodiment 200B of an interior UAV patrol route and home and illustrates how an interior UAV patrol route 298 can be integrated with an exterior UAV patrol route such that a single UAV can perform both interior and exterior patrols. Regarding altitude, for interior flights, it may be possible for a user to define a set distance from the ceiling for patrols and flights, such as 1.5 feet below the ceiling.

Logistically, an interior patrol can be configured and performed similarly to the exterior patrol of FIG. 2A. A user may define a patrol route, waypoints associated with various home automation devices or locations within the home, and events that trigger responses. Illustrated in FIG. 2B is UAV access point 292. UAV access point 292 may allow a UAV to move between the interior and exterior of home 214. For instance, following an interior patrol, UAV 199 may perform an exterior patrol after passing through UAV access point 292. UAV access point 292 may be similar to a “doggie door.” UAV access point 292 may be electronically controlled by a home automation host system to open and close and, possibly, lock when not in use. Alternatively, UAV access point 292 may be passive, similar to a typical “doggie door,” such that the UAV pushes against a panel to move in and out of home 214. UAV access point 292 may be sized and placed appropriately to limit any form of access that could be obtained to home 214 by intruders. Alternatively, UAV access point 292 may not be present and two separate UAVs may be used for the interior and exterior of home 214.

In some embodiments, a user may desire to define a particular no-fly zone 299 which UAV 199 is never permitted to enter. For instance, obstacles may be present in defined no-fly zone 299 that can cause a significant problem for UAV 199, such as a chandelier made of glass. Such a defined no-fly zone 299 may also be created for the exterior of the home. Multiple no-fly zones may be present both inside and/or outside of a home in various embodiments.

Also present in embodiment 200B is UAV perch 295. One or more UAV perches may be present inside and/or outside of home 214. UAV perch 295 may provide a location, away from UAV dock 220, at which UAV 199 can land and recharge. While at UAV perch 295, UAV 199 may function as a “fixed” location camera to monitor the environment nearby. Functionally, UAV perch 295 may be similar to UAV dock 220. Since small drones that are capable of flying inside of home 214 may have a short battery life for flying, one or more UAV perches may be used to extend the range of UAV 199. UAV perch 295 may have the ability to receive commands to physically reposition UAV 199, thus allowing the camera of UAV 199 to be directionally oriented to monitor the ambient environment of UAV perch 295.

Unpowered perches are also possible. An unpowered perch may not provide charging capabilities for UAV 199, but may allow the UAV to monitor a location for a given time without having to consume power to remain airborne. Regardless of whether a UAV perch is powered or unpowered, a UAV perch allows a UAV to reduce its output noise since it does not need to remain airborne via spinning rotors (or any other form of powered flight). Such a reduction in noise may be useful for surreptitious monitoring of a room or other environment.

Also present in embodiment 200B is UAV payload dispenser 291. UAV payload dispenser 291 may be incorporated as part of UAV Perch 295, UAV dock 220, or may be a separate device (as illustrated in FIG. 2B). UAV payload dispenser 291 may allow a UAV to pick up various payloads for different applications (e.g., pest control, candy delivery, medicine delivery, repelling burglars, dropping confetti, delivering gifts, etc.). One or more (e.g., five) payloads may be loaded into UAV payload dispenser 291. UAV 199 may dock with UAV payload dispenser 291 and be coupled with an appropriate payload for an action to be taken by UAV 199. In some embodiments, UAV 199 may carry multiple payloads simultaneously, in other embodiments, UAV 199 is restricted to a single payload. Some possible payloads that could be coupled with UAV 199 by UAV payload dispenser 291 can include mace, pills, notes, a horn, an extra battery, a wireless headset, aerosol-based repellant, UV paint to track with a UV sensor, PLIR to track heat emitting life, a water jet (with a water reservoir), a spring-loaded track dart, a Taser, etc.

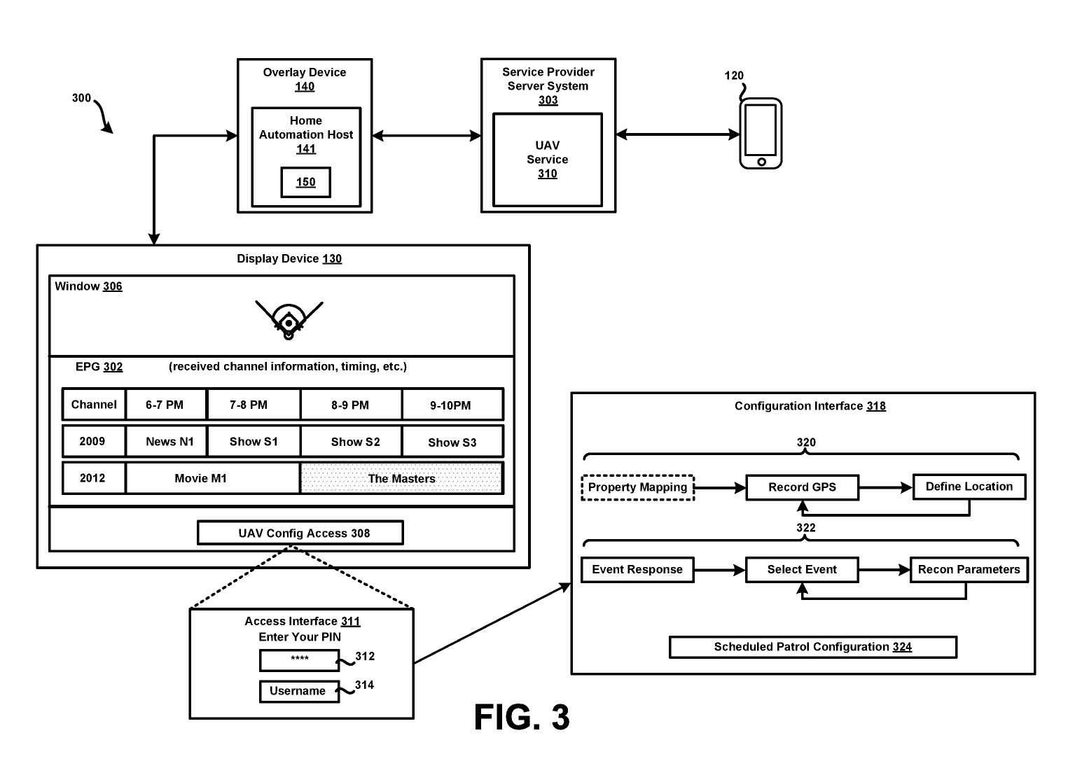

Referring to FIG. 3, a system including a home automation host that executes a UAV monitoring service 150 is presented. Overlay device 140 may overlay home automation data from home automation host 141 onto a television signal output by a television receiver provided to display device 130. Alternatively, the functionality of overlay device 140 may be incorporated as part of a television receiver (e.g., set top box television receiver) or some other form of computerized device. In FIG. 3, television programming output by a television receiver may be presented in window 306. Electronic programming guide (EPG) 302, which is presented based on television programming information received from a service provider, may also be output by the television receiver in response to a user request from mobile device 120 or remote control. Overlay device 140 may overlay a home automation interface onto the video signal output to display device 130, such as including UAV configuration access 308.

When selected, UAV configuration access 308 may solicit a password, identifier, PIN, or other form of input 312 that is used to confirm that the user is permitted to control UAV 199. A proper username 314 and password combination submitted may be confirmed by either home automation host 141 or service provider server(s) 303 (accessible via the Internet).

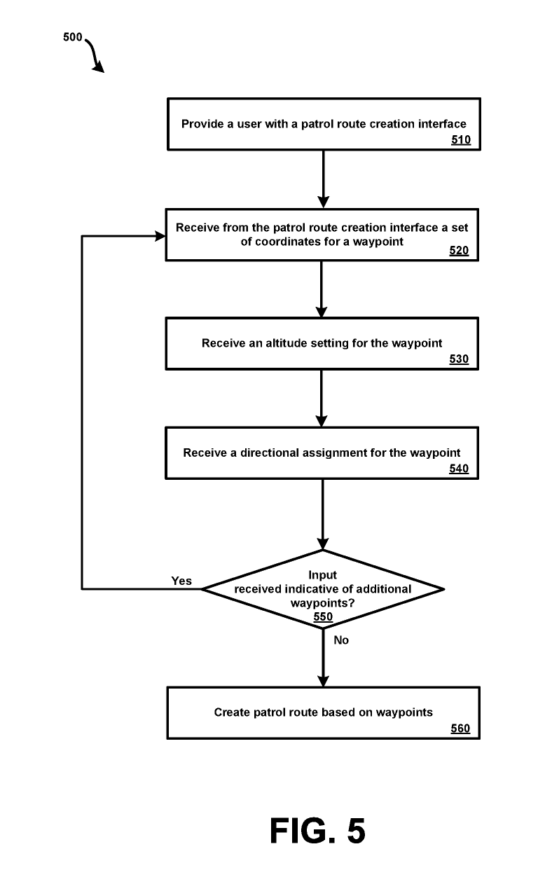

Access may be permitted to UAV configuration interface 318 via access interface 311. UAV service 310 may receive, store, and manage interaction between UAV monitoring service 150, mobile device 120, and any other computerized device through which a user connects via the Internet to retrieve data related to UAV 199. Via UAV configuration interface 318, a user may perform an initial property mapping or patrol route creation process via procedure 320. Embodiments of procedure 320 are detailed in relation to FIG. 5. Procedure 322 may permit a user to define actions such as: 1) which home automation events should trigger a response involving UAV 199; 2) what type of response should be elicited by the UAV; 3) whether an alert should be sent to mobile device 120; 4) whether video and/or audio should be recorded; 5) whether other home automation (HA) devices should take action. Procedure 322 may permit a user to select a particular event that may occur and provide various patrol or reconnaissance parameters. Table 1 provides an example of data that may be provided by the user and/or set by default (e.g., by the service provider). It should be understood that Table 1 is merely an example.

TABLE 1

| | | | Type of | | | | Other HA |
|---|---|---|---|---|---|---|---|
| | | UAV | UAV | Waypoint | Video/Audio | Alert | Device |
| HA Device | HA Event | Response? | Response | Target | Capture | Mobile? | Response? |
| Window | Window | Yes | Spot | #27, 2 | Yes | Yes | Intercom - |
| Sensor | actuation | | | minutes | | | Play Music |
| | while alarm | | | | | | |
| | system | | | | | | |
| | armed | | | | | | |
| Smoke | Smoke | Yes | Patrol | Hover | Yes | Yes | No |
| Alarm | Detected | | | 10 | | | |
| | | | | seconds | | | |
| | | | | at each | | | |
| | | | | waypoint | | | |
| Irrigation | Water flow | Yes | Patrol | No | Yes | No | No |
| System | detected | | | hover | | | |
| | outside of | | | | | | |
| | activation | | | | | | |
| | period | | | | | | |

As exemplified in Table 1, a user can define if and how UAV 199 is to be used to respond to home automation data received by home automation host 141 from another home automation device. For instance, a “spot” type of UAV response may involve the UAV proceeding to a subset of waypoints, other waypoints either being skipped or not hovered at by the UAV. Video and/or audio captured by UAV 199 may streamed to home automation host 141, which may transmit some (e.g., various image still) or all video to a display device, UAV service 310 of service provider server system 303 and/or to mobile device 120. In some embodiments, service provider server system 303 relay audio and/or video from home automation host 141 to mobile device 120 as appropriate. For example, video captured in relation to the irrigation system may be received and stored by home automation host 141 and/or UAV service 310 of service provider server system 303, but may not be streamed to mobile device 120. However, for smoke being detected, mobile device 120 may be alerted and the video and/or audio content may be streamed “live” or in “real time.” Real time refers to substantially little time elapsing between the capture of the video and/or audio by UAV 199 and the video and/or audio being output by mobile device 120. For instance, less than 2, 5, or 10 seconds may elapse between the capture of the video and/or audio by UAV 199 and mobile device 120 outputting such video and/or audio. Further, any video and/or audio that has been received by home automation host 141 and stored may be streamed to mobile device 120 upon the user's request.

Scheduled patrol configuration 324 may permit a user to define a schedule of when UAV 199 should follow a patrol route or randomly patrol around or near a home. Scheduled patrol configuration 324 may, for instance, allow a user to define that a patrol should be performed once per day at a fixed time (e.g., 7 PM), sunset (having a time that can be retrieved from the Internet and helps guarantee that enough natural light is preset for video capture), or a random time. A scheduled patrol is not triggered by a specific home automation event, but rather by the schedule indicating that a defined time of day and/or day of week has occurred or upon user request. Data, such as weather data retrieved from the Internet, can be used to cancel a patrol, such as if high wind, rain, or hail is predicted and the UAV may be damaged. Further, such weather data (which could include sunrise/sunset times) may be useful to save the UAV from having to fly a patrol during which low visibility is expected or observed.

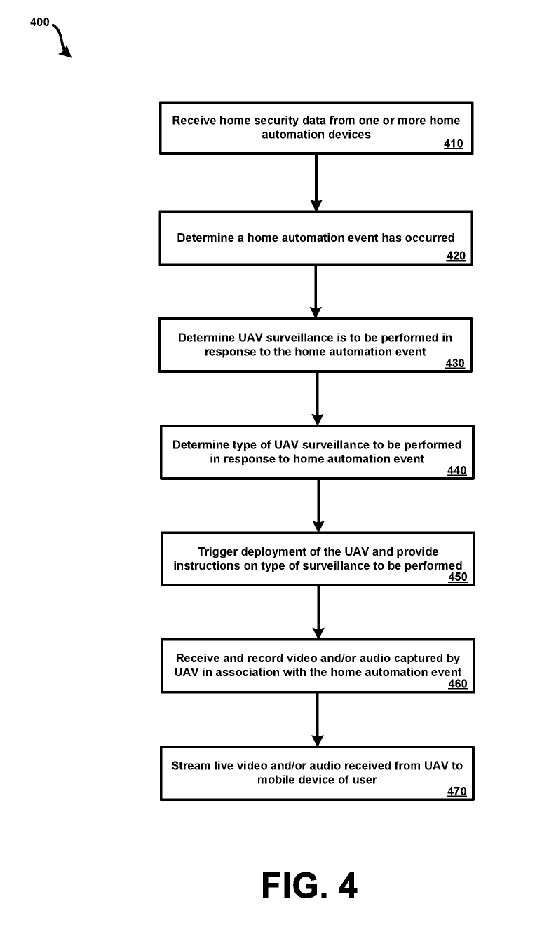

FIG. 4 illustrates an embodiment of a method 400 for dynamic video surveillance of a home (or other form of structure). “Dynamic” video surveillance refers to the concept that how video surveillance is performed by the UAV is affected by the event that triggers the UAV's surveillance flight. For instance, a scheduled patrol is performed differently than a non-scheduled flight occurring in response to triggering security- or safety-related data being received by a home automation host system from another home automation device. Method 400 may be performed using the systems, device, and interfaces of FIGS. 1-3. Each step of method 400 may be performed by a home automation host system, which can reside on an overlay device, television receiver, or some other form of computerized home-automation host system that is either local or remote to the user's home.

At block 410, home automation data is received from one or more home automation devices, such as one or more of the various home automation devices detailed in FIG. 1. The home automation host system can receive such information, store some or all of such information, and take appropriate action in response to such information.

At block 420, the home automation host system determines that a home automation event has occurred. Such an event may have various sources. Home automation data received at block 410 may be analyzed and determine to constitute a home automation event to which the home automation host system is to respond. Such a determination may be based on user-defined preferences, such as in relation to Table 1, that related particular actions to be performed by a home automation host system in response to received home automation data. The event of block 420 can be a message received via the Internet from a remote service provider's server system, which may have in turn, been received by the server system from a user's mobile device or other device capable of communicating with the service provider's server system via the Internet. The event may also be a scheduled event. For instance, a daily, hourly, or weekly scheduled patrol may be scheduled for a particular time of day. In some embodiments, a patrol is triggered to occur at a random time during a day or at a random time within a predefined time window (e.g., sometime between 5-8 PM). A patrol may also be based on another event, such as a user setting the home automation event to “sleep” mode to signify that the user is going bed or the user turning on a display device connected with the overlay device during a certain time period (e.g., when a user sits down to watch television between 7-11 PM). A scheduled patrol may also be triggered by a time of a natural event, such as sunset or sunrise. Such an event may be identified based on detected outdoor light levels or based on a query to an Internet server that responds with a time for sunrise and/or sunset for the location (e.g., zip code, city), of the user's home. A scheduled patrol could be blocked or skipped based on adverse weather data (e.g., based on zip code) or some other “no fly” condition.

At block 430, a determination may be made whether the home automation event of block 420 should be responded to with a UAV flight. For instance, a table, database, or other data storage arrangement that stores information similar to Table 1 may be accessed to determine if a UAV flight is the appropriate response. At block 430, if the HA event of block 420 was determined to be responded to with a UAV flight, a type of UAV flight may be identified at block 440 based on either default setting or user-defined preferences, such as presented in Table 1. Types of flight may include: patrol, patrol with hovering only at selected waypoints, direct-to-waypoint, user-controlled (manual), or service-provider controlled. Service provider controlled may be a flight that is controlled or managed by a service provider. A representative, such as communicating with home automation host 141 via service provider server system 303 may control a flight of UAV 199. Such a response may be particularly useful so that the representative can determine if police, security, or other emergency services should be dispatched by the service provider to the user's home. Video and other data gathered from the UAV may be used by police or other security arriving on site.

In response to blocks 420, 430, and/or 440, at block 450, the home automation host system may trigger deployment of the UAV and may provide a flight plan to the UAV as to the type of flight, the desired waypoints to be passed through or hovered at, at what points in the flight video and/or audio should be streamed, etc. The home automation host system may transmit a wireless (or wireline) instructions to UAV 199 or the UAV's dock that triggers the UAV to take to flight.

At block 460, while in flight, the UAV may transmit audio and/or video to the home automation host system for recording and/or relying to a remote server system of the service provider and/or a computerized device of the user, such as mobile device that is in communication with the service provider's server system. Such video and/or audio may be streamed in real-time to the user at block 470 for viewing either via a display device (e.g., television) connected with the overlay device or television receiver, via a mobile device of the user, or some other computerized device in communication with the service providers server. In some embodiments, additional commands may be provided to the UAV via the home automation host system to control and/or modify the UAV's flight. For instance, the user may provide an instruction that causes a speaker on the UAV to output a voice message provided in real time by the user, such as: “You are being recorded, get away from my house!” As another example, a light on the UAV may be flashed to alert an intruder or animal as to the presence of the UAV or to scare away the intruder or animal. If desired, a user may be able to trigger emergency services to visit the house by contacting or forwarding video to police, fire, or security services. The mobile device may be used to receive and process voice commands from a user. A user may speak a command instructing the UAV to go to a particular home automation device or waypoint. If a home automation device is spoken, the UAV may travel to an associated waypoint and point its camera in a direction associated with the waypoint.

Regardless of whether the video and/or audio received by the home automation host system is streamed to a user live, a recording of the video and/or audio may be made by the home automation host system and/or by the service providers server system. The recording may be associated with an indication of the triggering event (e.g., scheduled patrol, trigger by door opening when security alarm was activated, etc.), a date, a time, a representative frame (e.g., a frame captured while the UAV was at a waypoint associated with the flight), etc. the recording may be stored for up to a predefined period of time, such as two weeks, thus allowing a user ample time to play back video and/or audio from the flight if desired. The amount of time for which recordings are retained by either the home automation host system or the service provider's server system may be set by the user.

In some embodiments, video captured by the UAV may be analyzed, such as by the home automation host system, to determine if a particular event has occurred. For instance, facial recognition analysis may be performed to determine if a person outside of the home is known or is an unknown intruder. As another example, if a person (e.g., an elderly resident) who should not be outside the house is detected outside, a user may be notified. Or, as another example, if a particular car (e.g., a red one) is detected missing from the garage, the user may be notified or some other action may be taken.

FIG. 5 illustrates an embodiment of a method 500 for creating a patrol route for a UAV. Each step of method 500 may be performed by a home automation host system or a service provider's server system, which can reside on an overlay device, television receiver, or some other form of computerized home-automation host system that is either local or remote to the user's home. Method 500 may also be performed using or in conjunction with a mobile device, such as a cellular phone, of a user.

At block 510, a user may be presented with the patrol route creation interface. This interface may be presented to a user via the user's mobile device. In some embodiments, an application or webpage is loaded by the user's mobile device such that the patrol route creation interface can be presented allowing the user's home automation host system and/or the service providers server system to gather information from the user's mobile device.

The home automation host system or the service providers server system may receive from the patrol route creation interface a set of coordinates (e.g., GPS-based coordinates) for a waypoint at block 520. In some embodiments, a user may bring the mobile device to the physical location of the desired waypoint. While standing with the mobile device at the location of the desired waypoint, the user may provide input at block 520 that indicates the current location of the mobile device is to be used as a waypoint. In other embodiments, a user may be provided with a map on which the user touches locations that are desired to be used as waypoints. In another embodiment, a user may carry the UAV along the desired flight path such that the UAV can capture the desired route and/or waypoints. Further, by the user carrying the UAV, the user could have the UAV capture desired directions, angles, and zoom settings for recording of video or images at various waypoints.

At block 530, for the waypoint of block 520, the user may specify an altitude in terms of a distance above the ground. At different waypoints, the user may desire the UAV to be at different altitudes to avoid obstacles and/or provide a desired line of sight at an object such as the user's home. The altitude received at block 530 from the patrol route creation interface may be stored in conjunction with the waypoint of block 520.

Additionally, for the waypoint and altitude of blocks 520 and 530, a user may provide a directional assignment via the patrol route creation interface. The directional assignment may indicate a direction in which the user desires a camera and/or microphone of the UAV to be facing while the UAV is at the waypoint. For instance, if the waypoint is near a front door of the user's home, the directional assignment for the waypoint may cause a camera of the UAV to be pointed at the vicinity of the front door. In addition to the directional assignment, a user may provide an indication of a home automation device associated with the waypoint. By associating a waypoint with a particular home automation device, if an event at that home automation device triggers a UAV flight, the waypoint may be targeted for surveillance by having the UAV hover at the waypoint to the exclusion of hovering at other waypoints, or hovering longer than at other waypoints. A user may also define default amount of time for which the UAV should hover at the waypoint during a routine patrol. In some embodiments, the waypoint can be defined such that the UAV passes through the waypoint but does not hover at the waypoint for any length of time.

At block 540, a directional assignment and, possibly, a zoom assignment may be received for one or more of the waypoints. For embodiments in which the user physically carried the UAV along the desired patrol route, the directional assignment and/or zoom levels may have been measured, stored, and provided to the home-automation host system by the UAV. If a mobile device, such as a smart phone is being used, a camera of the smartphone may be enabled so that the user can see an approximation of what the UAV's camera will capture at a given directional assignment. While holding the mobile device is the desired directional assignment, the user may provide input that causes the mobile device's orientation and zoom level to be captured, stored, and transmitted to the home automation host system. In still other embodiments, may be possible for a user to use an interface, presented by the mobile device or another computer system, and specify a direction, level of inclination or declination, and zoom level (e.g., point north with 5 degrees of inclination over the horizon, with a 1.5× zoom). In other embodiments, a beacon, which may be simple graphical sticker with a particular pattern on it, may be placed in locations on which the UAV's camera should focus. Such beacons may be found via image analysis. In other embodiments, the beacons may take a form different than a simple sticker, such as a wireless transmitted that output a signal that permits the source to be accurately located.

At block 550, input may be received from the user via the patrol route creation interface that indicates whether additional waypoints are to be provided by the user. If not, method 500 may proceed to block 560. If additional waypoints are to be provided, method 500 may proceed back to block 520 and repeat blocks 520 through 540 until all desired waypoints have been specified by the user.

At block 560, the patrol route may be created by the home automation host system, the UAV, or the service providers server system based on the waypoints, altitudes, and directional assignments received in method 500. A proposed route through the various waypoints for the patrol route may be presented to the user via the patrol route creation interface. Via the patrol route creation interface, the user may have the ability to test, step through, fine-tune the patrol route, modify waypoints, alter in order of the waypoints, and view a proposed route that passes through the waypoints. That is, in some embodiments, from the waypoints provided by the user, the home automation host system, the UAV, or the service providers server system may determine a efficient route through the waypoints. In other embodiments, the order in which a user has provided or reordered the waypoints is used as an order for which the UAV will travel. If a loop is specified by the waypoints (e.g., around a house), the user may specify whether the UAV is permitted to travel the route clockwise and/or counterclockwise. The patrol route interface may also permit a user to associate one or more waypoints with particular home automation devices or objects (e.g., doors, windows, pools, etc.)

The patrol route created as part of method 500 may be used for routine patrols of the UAV and also if the UAV is being used to respond to particular triggering data from another home automation device. Using similar techniques as at block 520 through 540, the user may use patrol route creation interface to define an outer boundary outside of which the UAV is not permitted to travel. Therefore, if the UAV is malfunctioning, blown off course, under manual control (by a user or representative of the service provider), or for some other reason is deviating from a defined patrol route, defined outer boundaries may where the UAV is deactivated (and allowed to crash) or is caused to immediately land, turn around, or other specified action. The user may also define minimum and maximum altitudes to prevent the UAV from going too high or descending dangerously low when a deviation from the patrol route occurs. For instance, outer defined boundaries and minimum and maximum altitudes may be especially useful if a user is controlling the UAV remotely from a computerized device such as an overlay device or mobile device or a representative of the service provider is controlling the UAV (and, thus, may be unfamiliar with the user's home area). In some embodiments, a user may define one or more fly zones in which the home-automation host system or a cloud-based system determines the best flight plan for the UAV to follow.

As a variation of method 500, rather than a user defining particular waypoints, the user may cause the patrol mapping interface being executed on the mobile device to enter a “record” mode. The user may then, with mobile device in hand, walk along a route that the user wants to use as the patrol route. While walking, the mobile device may periodically (e.g., once per second) capture GPS coordinates that will be used for mapping the patrol route. The user may “pause” the recording when necessary to walk around objects that the UAV will be able to fly over (e.g., a fence, deck furniture). Once the user has fully walked the desired route, the user may use the patrol route creation interface to define altitudes, associated home automation devices and objects, and directions for the UAV's camera to point. A patrol route may then be created from the input information. Further, based on the orientation of the mobile device, which may be observed by the camera of the mobile device being activated, the user may define camera orientation settings for use by the UAV camera. The user may be permitted to fine tune the created route using the interface.

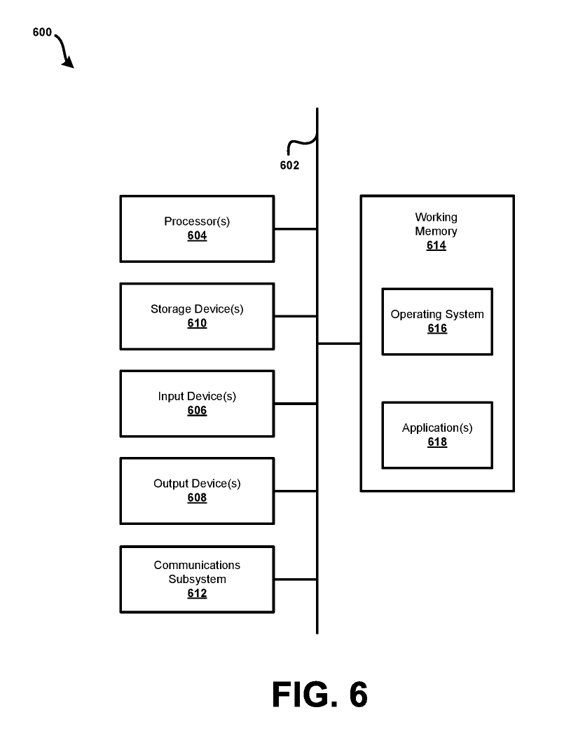

FIG. 6 shows an example computer system 600 or computerized device 600 in accordance with the disclosure. An example of a computer system or device includes a particular home automation-related sensor, device, system, controller, monitor, or detector, an enterprise server, blade server, desktop computer, laptop computer, tablet computer, personal data assistant, smartphone, gaming console, STB, television receiver, UAV, and/or any other type of machine configured for performing calculations. Any particular one of the previously-described computing devices may be wholly or at least partially configured to exhibit features similar to the computer system 600, such as any of the respective elements of at least FIG. 1 through FIG. 3. In this manner, any of one or more of the respective elements of at least FIG. 1 through FIG. 3 may be configured and/or arranged, wholly or at least partially, for enabling an end-user to access home automation features or functionality directly from or via one or more interfaces that might normally be used to access television-related programming and services, in manner consistent with that discussed above in connection with FIGS. 1-3.

The computerized device 600 is shown comprising hardware elements that may be electrically coupled via a bus 602 (or may otherwise be in communication, as appropriate). The hardware elements may include a processing unit with one or more processors 604, including without limitation one or more general-purpose processors and/or one or more special-purpose processors (such as digital signal processing chips, graphics acceleration processors, and/or the like); one or more input devices 606, which may include without limitation a remote control, a mouse, a keyboard, and/or the like; and one or more output devices 608, which may include without limitation a presentation device (e.g., television), a printer, and/or the like.

The computer system 600 may further include (and/or be in communication with) one or more non-transitory storage devices 610, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computerized device 600 might also include a communications subsystem 612, which may include without limitation a modem, a network card (wireless and/or wired), an infrared communication device, a wireless communication device and/or a chipset such as a Bluetooth™ device, 602.11 device, WiFi device, WiMax device, cellular communication facilities such as GSM (Global System for Mobile Communications), W-CDMA (Wideband Code Division Multiple Access), LTE (Long Term Evolution), etc., and/or the like. The communications subsystem 612 may permit data to be exchanged with a network (such as the network described below, to name one example), other computer systems, and/or any other devices described herein. In many examples, the computer system 600 will further comprise a working memory 614, which may include a random access memory and/or a read-only memory device, as described above.

The computerized device 600 also may comprise software elements, shown as being currently located within the working memory 614, including an operating system 616, device drivers, executable libraries, and/or other code, such as one or more application programs 618, which may comprise computer programs provided by various examples, and/or may be designed to implement methods, and/or configure systems, provided by other examples, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a non-transitory computer-readable storage medium, such as the storage device(s) 610 described above. In some cases, the storage medium might be incorporated within a computer system, such as computer system 600. In other examples, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computerized device 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some examples may employ a computer system (such as the computerized device 600) to perform methods in accordance with various examples of the disclosure. According to a set of examples, some or all of the procedures of such methods are performed by the computer system 600 in response to one or more processors 604 executing one or more sequences of one or more instructions (which might be incorporated into the operating system 616 and/or other code, such as an application program) contained in the working memory 614. Such instructions may be read into the working memory 614 from another computer-readable medium, such as one or more of the storage device(s) 610. Merely by way of example, execution of the sequences of instructions contained in the working memory 614 may cause the processor(s) 604 to perform one or more procedures of the methods described herein.

The terms “machine-readable medium” and “computer-readable medium,” as used herein, may refer to any non-transitory medium that participates in providing data that causes a machine to operate in a specific fashion. In an embodiment implemented using the computerized device 600, various computer-readable media might be involved in providing instructions/code to processor(s) 604 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 610. Volatile media may include, without limitation, dynamic memory, such as the working memory 614.

Example forms of physical and/or tangible computer-readable media may include a floppy disk, a flexible disk, hard disk, magnetic tape, or any other magnetic medium, a compact disc, any other optical medium, ROM (Read Only Memory), RAM (Random Access Memory), and etc., any other memory chip or cartridge, or any other medium from which a computer may read instructions and/or code. Various forms of computer-readable media may be involved in carrying one or more sequences of one or more instructions to the processor(s) 604 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 612 (and/or components thereof) generally will receive signals, and the bus 602 then might carry the signals (and/or the data, instructions, etc. carried by the signals) to the working memory 614, from which the processor(s) 604 retrieves and executes the instructions. The instructions received by the working memory 614 may optionally be stored on one or more non-transitory storage devices 610 either before or after execution by the processor(s) 604. It should further be understood that the components of computerized device 600 can be distributed across a network. For example, some processing may be performed in one location using a first processor while other processing may be performed by another processor remote from the first processor. Other components of computer system 600 may be similarly distributed. As such, computerized device 600 may be interpreted as a distributed computing system that performs processing in multiple locations. In some instances, computer system 600 may be interpreted as a single computing device, such as a distinct laptop, desktop computer, or the like, depending on the context.

The methods, systems, and devices discussed above are examples. Various configurations may omit, substitute, or add various method steps or procedures, or system components as appropriate. For instance, in alternative configurations, the methods may be performed in an order different from that described, and/or various stages or steps or modules may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example examples described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for dynamic video surveillance of a home, the method comprising:
receiving, by a home automation host system, home automation data from a plurality of home automation devices via wireless communication;
determining, by the home automation host system, a home automation event has occurred;
determining to perform unmanned aerial vehicle (UAV) surveillance of the home in response to the home automation event;
triggering, by the home automation host system, deployment of a UAV in response to determining to perform the UAV surveillance of the home;
receiving, by the home automation host system, video captured by the UAV of a portion of the home; and
recording, by the home automation host system, the video captured by the UAV of the portion of the home in association with an indication of the home automation event that triggered deployment of the UAV.

2. The method for dynamic video surveillance of the home of claim 1, wherein the home automation event is a scheduled aerial patrol event of an exterior and interior of the home at least partially based on a time of day that follows a user-created patrol route.

3. The method for dynamic video surveillance of the home of claim 1, wherein the home automation event is unscheduled and is based on home automation data received from a home automation device of the plurality of home automation devices.

4. The method for dynamic video surveillance of the home of claim 3, wherein determining to perform the UAV surveillance of the home in response to the home automation event comprises:
comparing the home automation data received from the home automation device with a stored database of defined responses, wherein the stored database of defined responses indicates various instances of home automation data that are to trigger UAV surveillance; and
determining that the home automation data matches a defined response of the stored database of defined responses, wherein the defined response indicates that UAV surveillance is to be performed and a type of UAV surveillance to perform.

5. The method for dynamic video surveillance of the home of claim 1, further comprising:
streaming, by the home automation host system, via a network connection, to a mobile device, the video captured by the UAV of the portion of the home.

6. The method for dynamic video surveillance of the home of claim 1, further comprising:
creating a patrol route for the UAV at least partially around the exterior of the home based on coordinates defined by a user.

7. The method for dynamic video surveillance of the home of claim 6, wherein creating the patrol route for the UAV comprises:
receiving a first set of coordinates from a mobile device of the user at a first waypoint to be included as part of the patrol route, wherein the mobile device is physically located at the first set of coordinates;
receiving a second set of coordinates from the mobile device of the user at a second waypoint to be included as part of the patrol route wherein the mobile device is physically located at the second set of coordinates; and
defining the patrol route to include the first waypoint and the second waypoint.

8. The method for dynamic video surveillance of the home of claim 7, wherein creating the patrol route for the UAV further comprises:
receiving, for each waypoint, a desired altitude for the UAV from the mobile device of the user, wherein defining the patrol route is at least partially based on the desired altitude received for each waypoint.

9. The method for dynamic video surveillance of the home of claim 1, wherein determining to perform the UAV surveillance of the portion of the home in response to the home automation event comprises selecting a type of UAV surveillance from the group consisting of: spot surveillance and patrol route surveillance, wherein the spot surveillance involves the UAV proceeding to a defined waypoint associated with received home security data and the patrol route surveillance comprises the UAV flying along a defined patrol route.

10. A home automation system for controlling video surveillance of a home, the home automation system comprising a home automation host system comprising:
one or more processors; and
a memory communicatively coupled with and readable by the one or more processors and having stored therein processor-readable instructions which, when executed by the one or more processors, cause the one or more processors to:
receive home automation data from a plurality of home automation devices via wireless communication;
determine that a home automation event has occurred;
determine to initiate unmanned aerial vehicle (UAV) surveillance of the home in response to the home automation event;
trigger deployment of a UAV in response to determining to initiate the UAV surveillance of the home;
receive video captured by the UAV of a portion of the home; and
record the video captured by the UAV of the portion of the home in association with an indication of the home automation event that triggered deployment of the UAV.

11. The home automation system for controlling video surveillance of the home of claim 10, wherein the home automation event is a scheduled aerial patrol event of an interior of the home at least partially based on a time of day that follows a user-created patrol route wherein the processor-readable instructions, when executed, further cause the one or more processors to: receive, from a user, a set of coordinates to be used as waypoints for the user-created patrol route.

12. The home automation system for controlling video surveillance of the home of claim 10, wherein the home automation system comprises the plurality of home automation devices and the home automation event is unscheduled and is based on home automation data received from a home automation device of the plurality of home automation devices.

13. The home automation system for controlling video surveillance of the home of claim 12, wherein the processor-readable instructions that, when executed, cause the one or more processors to determine to perform the UAV surveillance of the home in response to the home automation event comprise processor-readable instructions which, when executed, cause the one or more processors to:
compare the home automation data received from the home automation device with a stored database of defined responses, wherein the stored database of defined responses indicates various instances of home automation data that are to trigger UAV surveillance; and
determine that the home automation data matches a defined response of the stored database of defined responses, wherein the defined response indicates that UAV surveillance is to be performed and a type of UAV surveillance to perform.

14. The home automation system for controlling video surveillance of the home of claim 10, wherein the processor-readable instructions, when executed, further cause the one or more processors to:
stream, via a network connection, to a mobile device, the video captured by the UAV of the portion of the home.

15. The home automation host system for controlling video surveillance of the home of claim 10, wherein the processor-readable instructions, when executed, further cause the one or more processors to:
create a patrol route for the UAV at least partially around the exterior of the home based on coordinates defined by a user carrying the UAV to various locations desired to be on the patrol route, creating the patrol route comprising:
receive a first set of coordinates from the UAV a first waypoint to be included as part of the patrol route, wherein the UAV is physically located at the first set of coordinates;
receive a second set of coordinates from the UAV at a second waypoint to be included as part of the patrol route wherein the UAV is physically located at the second set of coordinates; and
define the patrol route to include the first waypoint and the second waypoint.

16. The home automation system for controlling video surveillance of the home of claim 15, wherein creating the patrol route for the UAV further comprises:
receive, for each waypoint, a desired altitude for the UAV from the user, wherein the processor-readable instructions that, when executed, cause the one or more processors to define the patrol route use the desired altitude received for each waypoint to define the patrol route.

17. The home automation system for controlling video surveillance of the home of claim 10, wherein the processor-readable instructions that, when executed, cause the one or more processors to determine to perform the UAV surveillance of the portion of the home in response to the home automation event comprise processor-readable instructions which, when executed, cause the one or more processors to:
select a type of UAV surveillance from the group consisting of: spot surveillance and patrol route surveillance, wherein the spot surveillance involves the UAV proceeding to a defined waypoint associated with received home security data and the patrol route surveillance comprises the UAV flying along a defined patrol route.

18. A non-transitory processor-readable medium for controlling video surveillance of a home comprising processor-readable instructions configured to cause one or more processors to:
receive home automation data from a plurality of home automation devices via wireless communication;
determine that a home automation event has occurred;
determine to initiate unmanned aerial vehicle (UAV) surveillance of the home in response to the home automation event;
select a type of UAV surveillance from the group consisting of: spot surveillance and patrol route surveillance, wherein the spot surveillance involves a UAV proceeding to a defined waypoint associated with received home security data and the patrol route surveillance comprises the UAV flying along a defined patrol route trigger deployment of the UAV in response to determining to initiate the UAV surveillance of the home, the UAV triggered to perform the selected type of UAV surveillance;
receive video captured by the UAV of a portion of the home; and
record the video captured by the UAV of the portion of the home in association with an indication of the home automation event that triggered deployment of the UAV.

19. The non-transitory processor-readable medium for controlling video surveillance of the home of claim 18, wherein the processor-readable instructions are further configured to cause the one or more processors to:
create a patrol route for the UAV at least partially around the exterior of the home based on coordinates defined by a user carrying a smartphone to various locations desired to be on the patrol route, creating the patrol route comprising:
receive a first set of coordinates from the smartphone for a first waypoint to be included as part of the patrol route, wherein the smartphone is physically located at the first set of coordinates;
receive a second set of coordinates from the smartphone at a second waypoint to be included as part of the patrol route wherein the smartphone is physically located at the second set of coordinates; and
define the patrol route to include the first waypoint and the second waypoint.

20. The non-transitory processor-readable medium for controlling video surveillance of the home of claim 18, wherein the processor-readable instructions are further configured to cause the one or more processors to:
receive, from a cellular phone of a user, an audio message to be output by the UAV while the UAV is deployed; and
transmit, to the UAV, the audio message for output.
